(19) United States
(12) Patent Application Publication
(10) Pub. No.: US 2011/0159863 A1
(43) Pub. Date: Jun. 30, 2011

(54) MOBILE COMMUNICATION DEVICE AND METHOD THEREOF

(75) Inventor: Lung DAI, Tu-Cheng (TW)

(73) Assignee: HON HAI PRECISION INDUSTRY CO., LTD., Tu-Cheng (TW)

(21) Appl. No.: 12/837,469

(22) Filed: Jul. 15, 2010

(30) Foreign Application Priority Data
Dec. 31, 2009 (TW) 98146084

(51) Int. Cl. H04M 3/00

(52) U.S. Cl. 455/418

(57) ABSTRACT

The disclosure provides a mobile communication device, comprising: a communicating module for establishing wireless link with an external communication device; a memory module for storing a preset information message and a preset time; a processor unit for generating a communication request and transmitting the communication request to the communicating module; a user interface; wherein the processor starts to count time after establishment of the wireless link, and synchronously detecting whether accumulated time is greater than or equal to the preset time, then, the user interface displays an information message. The disclosure further provides a mobile communication method.

### BACKGROUND

1. Technical Field

The present disclosure relates to mobile communication technology and, particularly, to a mobile communication device and method thereof.

2. Description of Related Art

Commonly, users put cell phones up to their ears before a link is established to avoid missing the beginning of the communication. However, radiation of the cell phones may suddenly increase for about one second when the link is established. This is perceived to be harmful to users.

What is needed, therefore, is a mobile communication device and a method thereof which can eliminate the above-described limitations.

### BRIEF DESCRIPTION OF THE DRAWINGS

The accompanying drawings, which are incorporated in and constitute a part of the specification, illustrate presently preferred embodiments of the disclosure, and together with the general description of the embodiments given below, serve to explain the principles of the disclosure in which:

FIG. 1 is a functional block diagram of a mobile communication device, according to an exemplary embodiment, and

FIG. 2 is flowchart of a mobile communication method, according to an exemplary embodiment.

### DETAILED DESCRIPTION

Embodiments of the present disclosure will be described next with reference to the accompanying drawings.

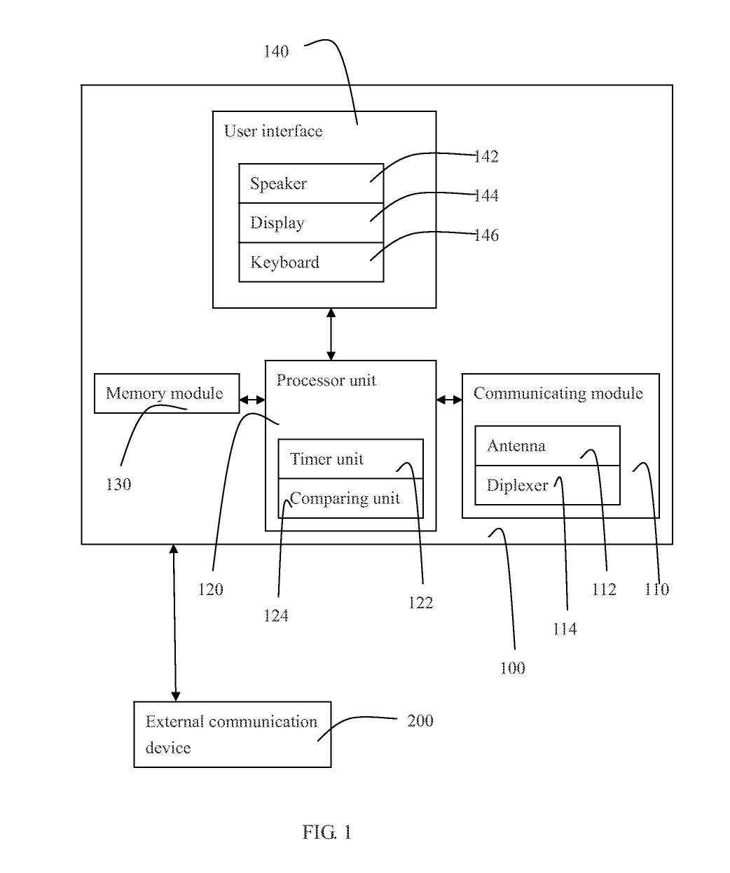

Referring to FIG. 1, a mobile communication device 100, according to an exemplary embodiment, comprises a communicating module 110, a processor unit 120 connected to the communicating module 110, a memory module 130 connected to the processor unit 120, and a user interface 140 connected to the processor unit 120. In the present embodiment, the mobile communication device 100 is a cellular phone.

The communicating module 110 is configured for establishing a wireless link with an external communication device 200 through base stations (not shown). The communicating module 110 includes at least an antenna 112 and a diplexer 114. The antenna 112 is configured for sending and receiving electromagnetic waves. The diplexer 114 is configured for filtering electromagnetic waves that are sent and received.

The processor unit 120 is configured for generating a communication request. The processor 120 further comprises a timer unit 122 and a comparing unit 124. The timer unit 122 is configured for counting time. The comparing unit 124 is configured for detecting the accumulated time of the timer unit 122.

The memory module 130 is configured for storing a preset information message and a preset time. The memory module 130 can be a flash memory. The preset information message can be in the form of an audio format, a visual format or other formats such as vibrate. The preset information message can be set in the memory module 130 during the manufacturing process of the mobile communication device 100, and can also be preset later manually. In the present embodiment, the preset information message is in visual format and set manually. The preset time can be set during manufacturing process of the mobile communication device 100. The preset time also can be set manually through the user interface 140. In the present embodiment, the preset time is also set manually, and the time set is 1 second.

The user interface 140 is configured for putting in or putting out information. The user interface 140 further comprises a speaker 142, a display 144 and a keyboard 146.

The memory module 130 stores a preset information message and a preset time, the processor unit 120 generates a communicating request, and the processor unit 120 transmits the communication request to the communicating module 110, and then the communication module 110 sends out the communication request to the external communication device 200. When the external communication device 200 accepts the communication request, a wireless link is established between the mobile communicating device 100 and the external device 200. Then the timer unit 122 starts to count time after the wireless link is established. The comparing unit 124 is configured for comparing the accumulated time of the timer unit 122 to the preset time. If the accumulated time of the timer unit 122 is greater than or equal to the preset time, the comparing unit 124 generates a trigger signal. The processor unit 120 answers the trigger signal, and reads the information message from the memory module 130, then displays the information message on the display 146 of the user interface 140. Thus, the user can read the information message and then start a call.

When the external communication device 200 sends a communication request to the communication device 100, the communication device 100 receives the communication request through the communicating module 110. The communicating module 110 transmits the communication request to the processor unit 120. When the processor unit 120 accepts the communication request, a wireless link is established between the communication device 100 and the external communication device 200. The timer unit 122 starts to count time after the wireless link has been established. The comparing unit 124 is configured for comparing the accumulated time of the timer unit 122 to the preset time. If the accumulated time is greater than or equal to the preset time, the comparing unit 124 generates a trigger signal. The processor unit 120 answers the trigger signal, and reads the information message from the memory module 130, and displays the information message by the display 146 of the user interface 140. Thus, the user can read the information message and then start a call.

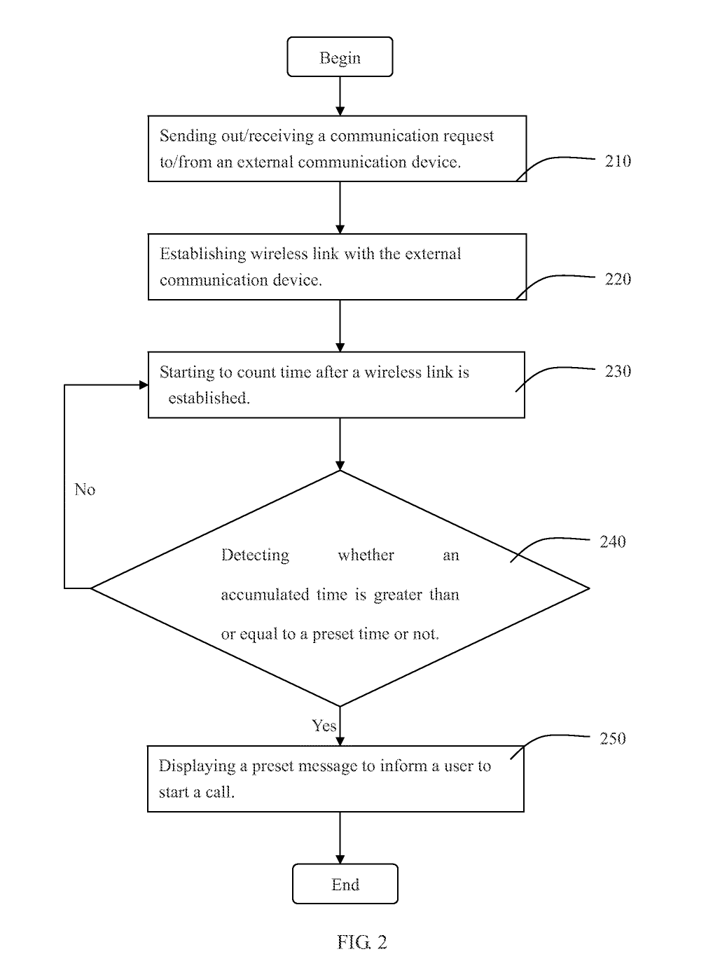

Referring to FIG. 2, a mobile communication method, according to an exemplary embodiment of the present disclosure, includes the following steps. Step 210, providing a mobile communication device sending out a communication request to an external communication device. It is understood that, the mobile communication device may also receive a communication request from the external communication device. Step 220, establishing a wireless link between the mobile communication device and the external communication device when the external communication device accepts the communication request. Step 230, starting to count time. Step 240, comparing whether or not the accumulated time is greater than or equal to a preset time. If yes, go to step 250, if no, return to step 230. Step 250, displaying an information message to inform a user when to start a call. The information message can be in an audio format, a visual format and so on. In the present embodiment, the information message is in a visual format. The preset time is one second.

Additional advantages and modifications will readily occur to those skilled in the art. Therefore, the disclosure in its broader aspects is not limited to the specific details and representative embodiments shown and described herein. Accordingly, various modifications may be made without departing form the spirit or scope of the general inventive concept as defined by the appended claims and their equivalents.

What is claimed is:

1. A mobile communication device, comprising:
a communicating module for establishing a wireless link with an external communication device;
a memory module connected to the communicating module for storing a preset information message and a preset time;
a processor unit connected to the memory module and for generating a communication request and transmitting the communication request to the communicating module, and the communicating module sending out the communication request to the external communication device; and
a user interface connected to the processor unit for putting in or putting out information;
wherein the processor unit starts to count time after the wireless link between the mobile communication device and the external communication device is established, and synchronously detects whether accumulated time is greater than or equal to the preset time, if so, the user interface displays an information message.

2. The mobile communication device of claim 1, wherein the processor unit further comprises a timer unit for counting time and a comparing unit for detecting whether the accumulated time of the timer unit is greater than or equal to the preset time.

3. The mobile communication device of claim 2, wherein the comparing unit generates an triggering signal when the accumulated time of the timer unit is greater than or equal to the preset time, the processor unit answers to the trigger signal and control the memory module to read the preset information message and the user interface to display the preset information message.

4. The mobile communication device of claim 1, wherein the preset information message is selected from one of an audio format and a visual format.

5. The mobile communication device of claim 1, wherein the preset time is set manually through the user interface.

6. The mobile communication device of claim 1, wherein the length of the preset time is one second.

7. A communication method, comprising:
sending out/receiving a communication request to/from an external communication device;
establishing a wireless link with the external communication device;
counting time after the wireless link established;
detecting whether an accumulated time is greater than or equal to a preset time or not;
displaying an information message when the accumulated time is greater than or equal to the preset time.

8. The mobile communication method of claim 7, wherein the preset time is set manually.

9. The mobile communication method of claim 7, wherein the length of the preset time is one second.

10. The mobile communication method of claim 7, wherein the preset information message is selected from one of an audio format and a visual format.
